(19) United States
(12) Patent Application Publication
(10) Pub. No.: US 2005/0245296 A1
(43) Pub. Date: Nov. 3, 2005

(54) Portable dual hinge type communication device usable as personal digital assistant

(75) Inventors: Sung-Hoon Hong, Suwon-si (KR); Yang-Jic Lee, Seoul (KR); Jong-Seong Lee, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 11/005,121

(22) Filed: Dec. 6, 2004

(30) Foreign Application Priority Data
Apr. 29, 2004 (KR) 30254/2004

(51) Int. Cl. H04M 1/00

(52) U.S. Cl. 455/575.3; 455/575.1

(57) ABSTRACT

A portable folder-type communication device, including a data input unit; a first hinge axis extending in the lateral direction of the data input unit along the rear end of the data input unit; a connection member rotatable relative to the data input unit about the first hinge axis; a second hinge axis extending in the direction perpendicular to the first hinge axis such that the second hinge axis can rotate about the first hinge axis; and a data output unit rotatable relative to the data input unit about the first hinge axis to allow the data output unit to rotate away from or towards the data input unit and also rotatable relative to the data input unit about the second hinge axis to allow the data output unit to rotate away from or towards the data input unit.

### PRIORITY

This application claims priority to an application entitled “PORTABLE DUAL HINGE TYPE COMMUNICATION DEVICE USABLE AS PERSONAL DIGITAL ASSISTANT”, filed in the Korean Intellectual Property Office on Apr. 29, 2004and assigned Ser. No. 2004-30254, the contents of which are incorporated herein by reference.

### BACKGROUND OF THE INVENTION

1. Field of the Invention

The present invention relates to a portable communication device including cellular phones, personal digital assistants, hand held personal computers, and digital communication devices, and more particularly to a portable dual hinge type communication device usable as a personal digital assistant (hereinafter, referred to as “PDA”) that can be conveniently used in a PDA mode as well as a phone mode.

2. Description of the Related Art

Generally, the term “portable communication devices” means electronic devices that are portable and enable owners of the devices to communicate through wireless communication. Such portable communication devices have become increasingly small, slim, and lightweight, whereby portability thereof is improved. Furthermore, such portable communication devices are capable of multimedia transmission, whereby the devices have various additional functions. Future portable communication devices will become even more miniaturized, and lightweight, with greater multipurpose functions, which will be easily adapted to various multimedia and Internet environments. The portable communication devices are commonly used throughout the world and considered an indispensable part of everyday life.

Based upon their configuration, portable communication devices may be classified into a variety of types. For example, portable communication devices may be classified as a bar-type communication device, a flip-type communication device, or a folder-type communication device. The bar-type communication device has a bar-type single housing, the flip-type communication device comprises a bar-type housing and a flip part pivotably attached to the housing, and the folder-type communication device comprises a bar-type housing and a folder part pivotably attached to the housing.

On the basis of where or how they are worn, the portable communication devices may also be classified into a necklace-type communication device and a wrist-type communication device. The necklace-type communication device is worn on the neck of a user by means of a string or lanyard, and the wrist-type communication device is worn on the wrist of the user.

On the basis of how they are opened or closed, the portable communication devices may be further classified into rotating-type communication devices and sliding-type communication devices. The rotating-type communication device is provided with two housings that are rotatably connected to each other while the housings are continuously facing each other. The rotating-type communication device is opened or closed by rotation of the two housings so that the housings are rotated apart from each other upon opening and rotated towards each other upon closing. On the other hand, the sliding-type communication device is provided with two housings, which slide in the longitudinal direction with respect to the two housings. The sliding-type communication device is opened or closed with a sliding movement of the two housings so that the housings are slid apart from or towards each other. The above-mentioned various types of communication devices are easily appreciated by a person of ordinary skill in the art to which the present invention pertains.

The portable communication devices have also been adapted to transmit/receive data at high speed in addition to their audio communication function. The portable communication devices use wireless communication technology for transmitting data at high speed, which will satisfy the increasing desires of the consuming public.

Another increasing trend provides a camera lens in each portable communication device to transmit image signals. The portable communication device has a camera lens module mounted outside or inside a main body of the portable communication device so that a user of the device can talk with another user of a similar device while looking at each other, or take pictures of his/her desired subjects.

The conventional portable folder-type communication device is constructed to conveniently perform a key input operation in a phone mode. In a PDA mode, however, the key input operation is typically too complicated to input data. As a result, the key input operation in the PDA mode is very inconvenient. The key input operation herein indicates a key pressing operation.

The liquid crystal display unit of the conventional portable communication device is rectangular. In the folder-type communication device, the horizontal width of the rectangular display unit is less than the vertical length of the rectangular display unit. For this reason, a wide screen is not adopted for the folder-type communication device. When a TV program or video on demand is watched using the portable communication device, a user cannot watch the TV program or video on demand on a wide screen. Consequently, it is increasingly required to provide a portable communication device with a display unit changeable in its orientation according to modes of the communication device to allow a greater horizontal length than a vertical length of the display unit.

### SUMMARY OF THE INVENTION

Therefore, the present invention has been made in view of the above problem, and it is an object of the present invention to provide a portable communication device usable as a PDA.

It is another object of the present invention to provide a portable communication device having an auxiliary housing rotatable about a first hinge axis or a second hinge axis according to a user's convenience or modes of the communication device to allow a horizontal width of a display unit is greater or less than the vertical length of the display unit as the user sees fit.

It is yet another object of the present invention to provide a portable communication device that allows convenient performance of a data input operation, i.e., a key pressing operation, in a phone mode or a PDA mode.

In accordance with one aspect of the present invention, the above and other objects can be accomplished by the provision of a portable folder-type communication device, which includes a main housing; a first hinge axis extending in the lateral direction of the main housing; a second hinge axis extending in the longitudinal direction of the main housing while parallel with one side of the main housing; and an auxiliary housing rotatable relative to the main housing about the first hinge axis to allow the auxiliary housing to be rotated away from the main housing or towards the main housing and also rotatable relative to the main housing about the second hinge axis to allow the auxiliary housing to be rotated away from the main housing or towards the main housing.

In accordance with another aspect of the present invention, there is provided a portable folder-type communication device, which includes a data input unit; a first hinge axis extending in the lateral direction of the data input unit along the rear end of the data input unit; a connection member rotatable relative to the data input unit about the first hinge axis; a second hinge axis extending in a direction perpendicular to the first hinge axis such that the second hinge axis can be rotated about the first hinge axis; and a data output unit rotatable relative to the data input unit about the first hinge axis to allow the data output unit to rotate away from or towards the data input unit and also rotatable relative to the data input unit about the second hinge axis to allow the data output unit to rotate away from or towards the data input unit.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view showing a portable communication device according to a preferred embodiment of the present invention;

FIG. 2 is a plan view of the portable communication device shown in FIG. 1;

FIG. 3 is a front view of the portable communication device shown in FIG. 1;

FIG. 4 is a perspective view of the portable communication device of FIG. 1 showing an auxiliary housing rotated open about a first hinge axis; and

FIG. 5 is a perspective view of the portable communication device of FIG. 1 showing the auxiliary housing rotated open about a second hinge axis.

### DETAILED DESCRIPTION OF THE PREFERRED EMBODIMENTS

Now, a preferred embodiment of the present invention will be described in detail with reference to the accompanying drawings. In the following, a detailed description of known functions and configurations incorporated herein will be omitted when it may obscure the subject matter of the present invention.

It should be noted that a portable communication device according to the present invention comprises a main housing and an auxiliary housing rotatable relative to the main housing about a laterally extending hinge axis or a longitudinally extending hinge axis, whereby a user can easily and conveniently perform a data input operation or check displayed data.

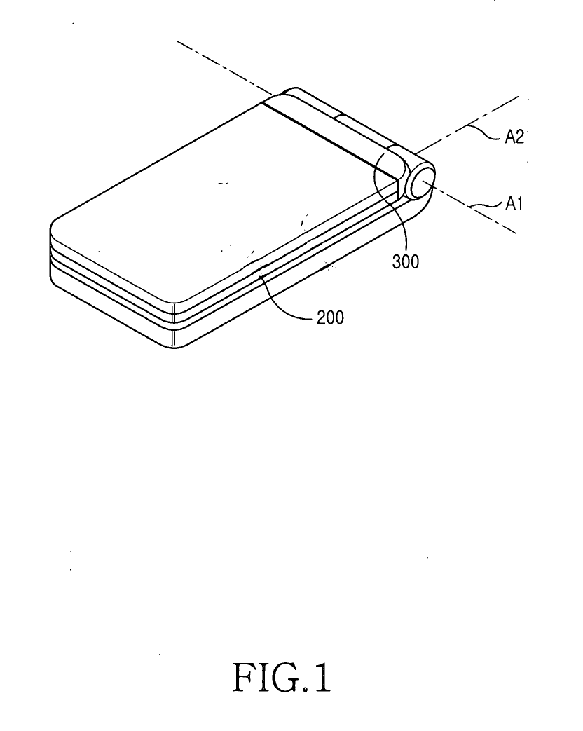

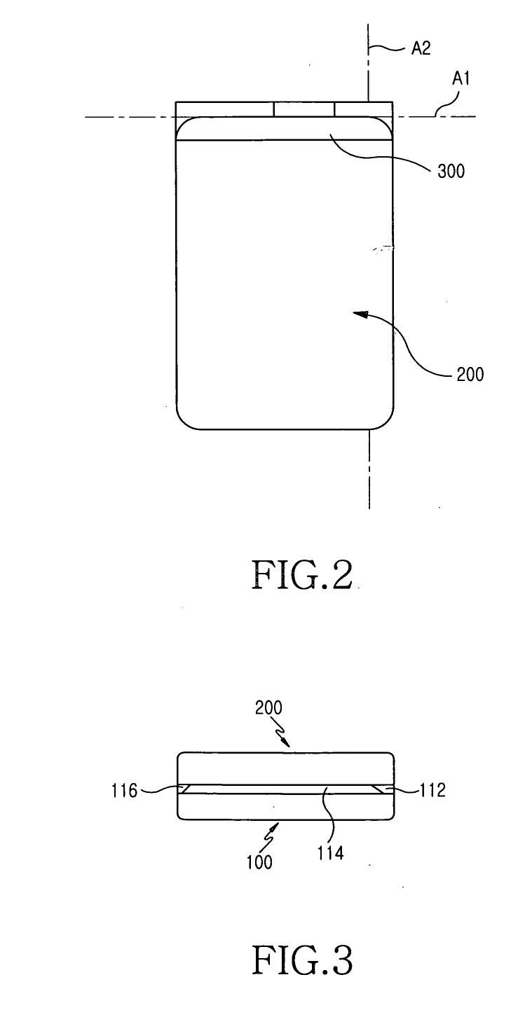

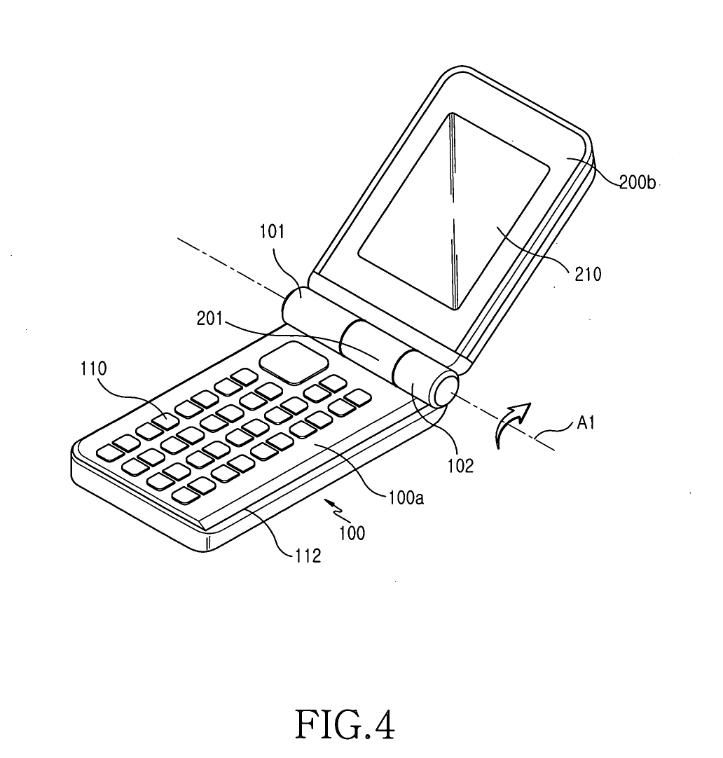

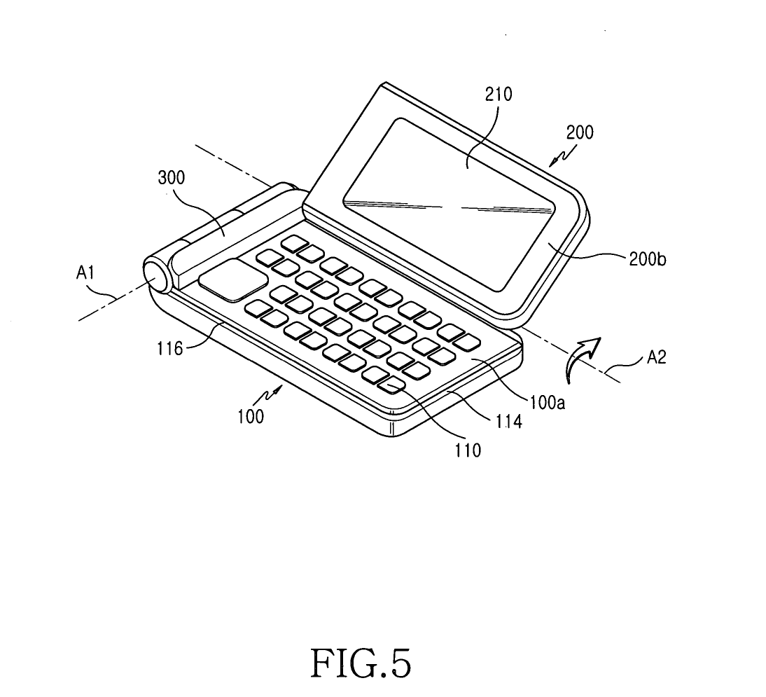

As shown in FIGS. 1 to 5, the portable communication device of the present invention includes a main housing 100; a first hinge axis A1 extending in the lateral direction of the main housing 100; a second hinge axis A2 extending in the longitudinal direction of the main housing 100 and generally perpendicular to the first hinge axis A1; and an auxiliary housing 200 rotatable relative to the main housing 100 about the first hinge axis A1 or the second hinge axis A2. Specifically, the auxiliary housing 200 is rotated away from the main housing 100 to open the portable communication device or towards the main housing 100 to close the portable communication device about the first hinge axis A1 as shown in FIG. 4. Similarly, the auxiliary housing 200 is rotated away from the main housing 100 to open the portable communication device or towards the main housing 100 to close the portable communication device about the second hinge axis A2 as shown in FIG. 5.

The main housing 100 and the auxiliary housing 200 are both rectangular. The auxiliary housing 200 is connected to the main housing 100 to allow the auxiliary housing 200 to be rotated relative to the main housing 100 about the first hinge axis A1. The lateral widths of the main housing 100 and the auxiliary housing 200 are different than the longitudinal lengths of the main housing 100 and the auxiliary housing 200, respectively. Preferably, the longitudinal lengths of the main housing 100 and the auxiliary housing 200 are greater than the lateral width of the main housing 100 and the auxiliary housing 200, respectively. The first hinge axis A1 extends in the lateral direction of the main housing 100 along the rear end of the main housing 100, and the second hinge axis A2 extends in the longitudinal direction of the auxiliary housing 200 along one side of the auxiliary housing 200. The second hinge axis A2 is perpendicular to the first hinge axis A1, and the second hinge axis A2 is rotated in the direction of the first hinge axis A1.

Between the main housing 100 and the auxiliary housing 200 is disposed a connection member 300. The connection member 300 is rotatable about the first hinge axis A1. The auxiliary housing 200 is rotatably connected to the main housing 100 by means of the connection member 300. The connection member 300 extends parallel to and along the first hinge axis A1. Preferably, the connection member 300 extends linearly. Also, the connection member 300 is disposed adjacent to the first hinge axis A1. Preferably, the second hinge axis A2 extends through the end of one side of the connection member 300.

The main housing 100 is provided at both sides of the rear end of the upper surface 100a with a pair of side hinge arms 101 and 102. On the upper surface 100a of the main housing 100 is disposed a keypad 110 comprising a plurality of keys. On the upper surface 100a of the main housing 100 is formed a first side recess 112, by which the auxiliary housing 200 can be easily rotated relative to the main housing 100 about the second hinge axis A2. Specifically, the first side recess 112 is formed at one side parallel to the longitudinal axis of the main housing 100 while linearly extending along the side of the main housing 100. A second side recess 116 may also be provided as shown in FIG. 3. The main housing 100 may be referred to as a data input unit since the keypad 110 is disposed on the upper surface 100a of the main housing 100.

The auxiliary housing 200 is provided at the lower surface 200b thereof with a liquid crystal display unit 210. It should be noted, therefore, that the auxiliary housing 200 may be referred to as a data output unit. The auxiliary housing 200 is provided with a central hinge arm 201, which is connected to the side hinge arms 101 and 102 by means of a first hinge module (not shown). The main housing 100 is provided at an end opposite the hinge arms with end recess 114 by which along with side recesses 112 and 116 the auxiliary housing 200 can be easily rotated relative to the main housing 100 about the first and second hinge axes A1 and A2, respectively.

When the auxiliary housing 200 is positioned flat on the main housing 100 as shown in FIG. 1, the second hinge axis A2 is parallel with one side of the upper surface 100a of the main housing 100. When the auxiliary housing 200 is rotated open relative to the main housing 100 about the second hinge axis A2 as shown in FIG. 5, one side of the auxiliary housing 200 contacts the one side of the main housing 100, adjacent to and along the first side recess 112 of the main housing 100.

FIG. 4 shows the portable communication device used in a phone mode, and FIG. 5 shows the portable communication device used in a PDA mode. As shown in FIG. 4, the portable communication device is arranged in the longitudinal direction. As shown in FIG. 5, the portable communication device is arranged in the lateral direction. The first hinge module provided for defining the first hinge axis A1 is mounted in the side hinge arms, and is not shown in the drawings. Also, a second hinge module, which is provided for defining the second hinge axis A2, is mounted in the end of one side of the connection member 300, and also is not shown in the drawings.

The rotation angle of the auxiliary housing 200 relative to the main housing 100 about the first hinge axis A1 is from 0 to 180 degrees, and the rotation angle of the auxiliary housing 200 relative to the main housing 100 about the second hinge axis A2 is from 0 to 180 degrees. Referring to FIG. 4, the auxiliary housing 200 is preferably rotated approximately 130 degrees open relative to the main housing 100 about the first hinge axis A1. Referring to FIG. the auxiliary housing 200 is preferably rotated approximately 150 degrees open relative to the main housing 100 about the second hinge axis A2.

The horizontal width of the display unit 210 is less than the vertical length of the display unit 210 as configured in FIG. 4. Conversely, the horizontal width of the display unit 210 is greater than the vertical length of the display unit 210 as configured in FIG. 5. Consequently, the portable communication device is preferably used as shown in FIG. 4 when the portable communication device is used in the phone mode. When a TV program or video on demand is watched or when used in the PDA mode, the portable communication device is preferably used as shown in FIG. 5.

As apparent from the above description, the present invention provides a portable communication device having an auxiliary housing rotatable about a first hinge axis or a second hinge axis. Consequently, the present invention has the effect that a key pressing operation can be easily and conveniently performed in a PDA mode as well as in a phone mode, and a wide screen is provided in the PDA mode. The present invention is suitably adopted for a smart phone.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

1. A portable communication device, comprising:
a main housing;
a first hinge axis extending in the lateral direction of the main housing;
a second hinge axis extending in the longitudinal direction of the main housing while being in parallel with at least one side of the main housing; and
an auxiliary housing rotatable relative to the main housing about the first hinge axis to allow the auxiliary housing to rotate away from the main housing and towards the main housing, and the auxiliary housing also rotatable relative to the main housing about the second hinge axis to allow the auxiliary housing to rotate away from the main housing and towards the main housing.

2. The device as set forth in claim 1, wherein the first hinge axis extends in the lateral direction of the main housing along a first end of the main housing, and the second hinge axis extends in the longitudinal direction of the auxiliary housing along a side of the auxiliary housing.

3. The device as set forth in claim 1, wherein the second hinge axis is in a common plane as the first hinge axis.

4. The device as set forth in claim 1, wherein the main housing is provided at at least one side thereof with a first recess for allowing the auxiliary housing to be rotated, the first recess continuously extending along the at least one side of the main housing.

5. The device as set forth in claim 4, wherein the main housing is provided at a second end and the side opposite the first recess with additional recesses.

6. The device as set forth in claim 1, further comprising: a connection member disposed between the main housing and the auxiliary housing, wherein the connection member is rotated about the first hinge axis when the auxiliary housing rotates about the first hinge axis, and the connection member connects the auxiliary housing to the main housing.

7. The device as set forth in claim 6, wherein the connection member extends parallel to the first hinge axis while being disposed adjacent to the first hinge axis.

8. The device as set forth in claim 1, wherein the second hinge axis is parallel with at least one side of an upper surface of the main housing when the auxiliary housing is positioned flat on the main housing in a closed position, and the at least one side of the auxiliary housing contacts a corresponding side of the main housing when the auxiliary housing is fully rotated open relative to the main housing about the second hinge axis.

9. The device as set forth in claim 1, wherein the longitudinal lengths of the main housing and the auxiliary housing are greater than the lateral widths of the main housing and the auxiliary housing, respectively.

10. A portable folder-type communication device, comprising:
a data input unit;
a first hinge axis extending in a lateral direction of the data input unit along a rear end of the data input unit;
a connection member rotatable relative to the data input unit about the first hinge axis;
a second hinge axis extending in a direction perpendicular to the first hinge axis such that the second hinge axis can be rotated about the first hinge axis; and
a data output unit rotatable relative to the data input unit about the first hinge axis such that the data output unit is rotated away from the data input unit and towards the data input unit, and also rotatable relative to the data input unit about the second hinge axis to allow the data output unit to rotate away from the data input unit and towards the data input unit.

11. The device as set forth in claim 10, wherein the second hinge axis extends along one side of the data input unit when the data output unit is positioned flat on the data input unit.

12. The device as set forth in claim 10, wherein the data input unit includes a keypad comprising a plurality of keys, and the data output unit includes a liquid crystal display unit.

13. The device as set forth in claim 10, wherein the data input unit is provided at at least one side of the upper surface thereof with a recess, the recess linearly extending along the side of the upper surface of the data input unit.

14. The device as set forth in claim 10, wherein the data input unit and the data output unit are each rectangular in shape, and the longitudinal lengths of the data input unit and the data output unit are greater than the lateral widths of the data input unit and the data output unit, respectively.
